(19) United States
(12) Patent Application Publication
(10) Pub. No.: US 2021/0370133 A1
(43) Pub. Date: Dec. 2, 2021

(54) SYSTEM AND METHOD FOR PROVIDING AUGMENTED REALITY INFORMATION AND SPORTS PERFORMANCE DATA OVER A WIRELESS NETWORK

(71) Applicant: Jennifer LaPoint, Orlando, FL (US)

(72) Inventor: Jennifer LaPoint, Orlando, FL (US)

(21) Appl. No.: 16/887,198

(22) Filed: May 29, 2020

(51) Int. Cl. A63B 24/00; A63F 13/798

(52) U.S. Cl. CPC A63B 24/0062; A63B 24/0006; A63B 24/0021; A63F 2300/8082; A63B 2024/0068; A63B 2024/0009; A63B 2024/0025; A63F 13/798

(57) ABSTRACT

The present invention discloses a method and system for providing sports performance data and motion data to a user. The system comprises a wireless device with a memory unit, a communication unit, and a data processing unit. The memory unit comprises a database having a plurality of pre-programmed inputs. The communication unit comprises a location identifying device for determining the location of a user. The data processing unit comprises a sensing module with sensors to measure and determine the movement of the users in accordance with sports which is then compared with a competitor over the network. A comparing module, via a processor and communication unit, receives and compares sports performance data of the users. A ranking module, via the processor calculates and ranks a user performance in a single competition or a variety of competition and provides ranking based on the common inputs received and the calculated performance obtained.

### TECHNICAL FIELD

The present invention generally relates to a portable wireless device application which is enhanced by a portable mobile augmented reality device and motion tracking devices.

### BACKGROUND

Today many hand-held, portable electronic and gaming devices provide a user the ability to instantly download, install, and play a variety of video games over a wireless network in real-time. These games further enable first-person features and allow the user to compete head-to-head with opponents throughout the world; however, there is no single gaming platform or system which incorporates augmented reality experiences and real sports motions together to give real sports players a video game look, feel, experience, variable reward system or wagering system.

Traditional gaming platforms allowed up to four players to be connected over a network. Advances in technology now provide for platforms that allow dozens of players to be connected in real-time within a collaborative space; however, there is no portable wireless device application, with or without an augmented reality experience, that allows a group of users to engage in a real sporting activity. This requires participants to be in the same location at the same time, thus limiting participation and type of real sports competition available. This also requires a method to digitize and quantify the sports action or motion of any activity with movement, like juggling, rolling a tire or planking.

To participate in most sports, the player (i.e., user) must be present at a specific, physical location at a defined time to participate with other similarly skilled competitors. For example, if a golfer wants to compete against another person in match play, they must be on the same hole of the golf course at the same time. This in-person requirement limits participation due to location, time, and participation constraints. No system exists wherein real sports activities are digitized, measured, compared, and allow for competing against others while one or more players are in different locations. This interaction only exists in video games which limit the real sports motions performed by the player. These inside methods of play are greatly limiting the amount and realness of the action and sports motion at player can create.

Conversely, playing a game or competing only against oneself does not provide for a realistic competitive experience, as each player has to imagine the competitor (e.g., doing pushups at home in one's living room is not as rewarding or motivating as competing against friends in a pushup competition with a worldwide audience reacting and commenting in real time). A lack of social interaction is frequently cited as the largest factor in what inhibits most people from participating in sporting activities and being more active It is less enjoyable when there is no way to measure, compare, compete or interaction with other teammates, coaches, competitors, or spectators. There is no current system for finding a player to engage with from a remote location at any time.

Receiving feedback on one's skill level or performance helps motivate and improve future performance. It is generally accepted by athletes that competing is more fun than practice, but not everyone has access to competition due to cost, location and/or access. Science indicates people who keep their focus on an attainable reward or goal while doing a physical activity find it to be easier and achieve more. Players find it more rewarding than repetitive training with no way to measure performance, benchmark or target training. Thus, a need exists for an digital sports system that can give the player away to benchmark, measure, compare and get feedback on every practice activity when no other live person or coach is available making pracice feel easier and rewarding them for incremental improvements like a real coaching interaction. This system would make every practice feel like the fun of a competition.

Currently players can record video of their sports performance for later viewing and use personal subjective judgements to make improvements; however, this is limited by the knowledge base of the judge/coach and would not be as precise as data driven judgements/coaching. Currently, there is not a single system which may be displayed on a variety of hand-held or portable systems that captures sports motion data in real-time and then critically analyzes the data through artificial intelligence and machine learning. This sports AI system could be used to replace actual live coaches and judges in sports that currently use subjective judging.

Practice is a necessary element for improving performance, however, it can be boring, especially if there is no one providing feedback or a measure of success. Competing is a valuable measure of skill and tells the player how much more practice is required to achieve a player's personal goals. When a player realizes some success, they become motivated to continue making further achievements. A user changes their perception of how hard the activity is when given a more easily attainable goal. There is no current device or application that allows the player to be continuously competing with members of the same sport in different locations of the world in real-time. There is no system of competition among multiple players from multiple locations, at different times and or in different sports. There is no system to build teams of individual sports players or mix sports players on one team. Today there is been mass sports event cancellation and self-quarantining, thus amplifying the need for a virtual sports competition system. Competing from home saves the player the cost and inconvenience of travel. Further, continuously competing drives the player to be better due to constant feedback on their success or failure, allowing the player to make micro changes to improve performance.

Currently, there are no sports utility applications that make real sports feel as though it were a video game. Gaming consoles known in the art allow a person in their living room to simulate sports play, but they do not allow for the player to be outside actually engaging in the sports activity that feels like video game action. There is no system of offering real sports players a multiple player gaming system and video game style play such as match play, team play or fantasy team play using the collection of real sports motion data captured with a portable wireless device or combination of devices.

There is no single gaming platform to combine video game sports play and real sports pay at different times but in one combined game and scoring system. Such an application could allow a sports fan or video game enthusiast to team up with or compete against a real sports player on vitual teams. Additionally, a player cannot combine their scores of both video game play and real play to become a combined play champion.

Devices are being put in sport equipment such as baseball bat and basketballs to track motion; however, this technology is not being integrated into application for both sports competition and sports betting (i.e., wagering). There is no one currently using digitized sports motion captured by a portable system of the everyday play of the average player for sports competition or wagering. Fan's cannot currently wager against other fans through a universal matrix based on categories such as the speed of play or arch of basketball in flight. While players can currently use smart balls with a motion tracking device built in their equipment or attached separately, such as smart watch, players cannot use metrics like acceleration, the angle of a jump, or any other sports specific data to compete anywhere, anytime with anyone. In addition, there is no system for fans to see, interact with, or wager on this data of the average sports participant or professional level sports collected by this type of portable wireless device system.

The current arts contain no application wherein a portable wireless device allows athletes to send real sports motion data to a coach for feedback in real-time. Such a system will allow the average athlete to access professional caliber coaching from any location at any time. This same system will allow coaches to be paid in real-time for this coaching service.

In addition, through machine learning created by collecting massive amounts of digitized sports action of multiple users combined with real professional level coaching inputs the system will get smarter and be able to provide artificial intelligent coaching in the application without further intervention from a real person.

The digitization of sports play will allow for storage and valuation of data provided to the system, allowing revenue share with users proving such data to the system. For example, a pro athlete will be provided a user tracking code to invite other users to the system and be given a revenue share for those users. Users data provided to the system can be valued so that the user can gain rewards of in-game, crypto or fiat currency for providing such data. It is the digitization of something currently not systematically measured that allows collection and the valuation of such data, thus revolutionizing how we value sports play and content.

### SUMMARY OF THE INVENTION

This summary is provided to introduce a variety of concepts in a simplified form that are further disclosed in the detailed description of the invention. This summary is not intended to identify key or essential inventive concepts of the claimed subject matter, nor is it intended for determining the scope of the claimed subject matter.

The present embodiments disclose a system for digitizing sports action or any solo activity with movement using portable wireless devices combined with an augmented reality experience including a video game look, feel, and reward system. In an embodiment, the system comprises a wireless device having a memory unit, a communication unit, and a data processing unit. In one embodiment, the memory unit comprises a database with one or more sports-related data, one or more skillsets required for measuring the performance of the user, and one or more performance data of the user. In one embodiment, the communication unit comprises a location identifying device for determining the actual location of at least one user. In an embodiment, the data processing unit comprises one or more sensing modules, comparing modules, ranking modules, and output modules. In one embodiment, the sensing module comprises one or more sensors to measure and track the movement of the users in accordance to the required skill to be performed, and performance data of the pre-determined sport or activity.

The comparing module, via a processor and communication unit receives sports performance data of one or more users to compare the sports performance data. The ranking module, via the processor calculates and ranks each user in accordance to the received compared data from the comparing module. The output module is configured to display a rank with respect to the user's performance, thereby motivating the user to continuously interact with the system.

The present embodiments also disclose a method for providing an augmented reality sports performance experience and capturing the data of a user, comprising the following steps: providing the user with software application for one or more wireless devices. Identifying the location of the user's device for determination the actual location of the users by a communication module. Measuring and determining the movement of the users via multiple sensors. Receiving sports performance motion data of one or more users over a network and allowing user information to be simultaneously uploaded and stored over the network. Comparing the sports performance motion data using a comparing module. Ranking the user's sports performance from compared motion data using a ranking module and displaying a rank by an output module.

In one embodiment, the user's device includes a near-eye display for augmented reality. Some examples of current augmented reality sports implementation include running against another runner that you can see next to you while fans cheer the player on, driving a real golf ball to a virtual hole on a virtual golf course, shooting foul shots with a real ball to a virtual basketball hoop, water skiing in a virtual slalom course, swimming against other swimmers who can be visualized using the augmented reality goggles, hunting a virtual lion in a park in a country where lions don't normally live. etc. The user of the device may optionally play with either real or virtual equipment or an augmented reality display. In a preferred embodiment, the user's physical motion could be tracked and collected to rank their performance with a competitor in a different location based on a plurality of pre-selected sub-categories such as location, gender, age, height, weight, difficulty level, and any other sport-specific performance criteria/data.

Moreover, in accordance with a preferred embodiment of the present invention, other aspects, advantages, and novel features of the present invention will become apparent from the following detailed description in conjunction with the drawings.

### BRIEF DESCRIPTION OF THE DRAWINGS

A more complete understanding of the present invention, and the advantages and features thereof, will be more readily understood by reference to the following detailed description when considered in conjunction with the accompanying drawings wherein:

FIG. 1 illustrates a system for providing an augmented reality event or sports performance data of a user, according to an embodiment of the present invention;

FIG. 2 illustrates a method for providing augmented reality sports event or performance data of the user according to the incorporated embodiments;

FIG. 3 illustrates a screenshot of the player dashboard interface, according to an embodiment of the present invention;

FIG. 4 illustrates a screenshot of a plurality of users ranked in a leaderboard as displayed by the graphical user interface, according to an embodiment of the present invention;

FIG. 5 illustrates a screenshot wherein a user is capturing an activity, according to an embodiment of the present invention

FIG. 6 illustrates a screenshot of the graphical user interface illustrating a schematic of the performed activity, according to an embodiment of the present invention;

FIG. 7 illustrates a schematic of a user engaging an activity while the user is in communication with the system, according to an embodiment of the present invention; and

FIG. 8 illustrates a schematic of a user engaging an activity while the user is in communication with the system, according to an embodiment of the present invention.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second” and the like, may be used solely to distinguish one entity or element from another entity or element without necessarily requiring or implying any physical or logical relationship or order between such entities or elements.

In general, the invention described herein relates to a portable wireless device application that is enhanced by a portable mobile augmented reality device and motion tracking devices such as a smartwatch or smart sports equipment. The application permits a first user to engage with any number of remote users. At least one user can utilize the augmented reality device and compete against other users either in real-time, or as a pre-recorded, or pre-analyzed sporting event. This application can allow virtual teams to compete against other virtual teams from different locations. For example, a team of family members could water ski against another family team skiing on another lake somewhere else. Also, a team of kids from camp could compete virtually against another kids camps in a different country. High School players can compete against their rival school while both teams of players are playing on their home campus saving schools money and bringing back competition to schools that have eliminated school sports due to costs.

The embodiments disclose a system of providing real-world sports performances into a network ecosystem and economy. This system of digitizing sports action will allow new ways to measure, compare and compete in sports, allowing for entirely new sports games to be created by the system or by players from these unique digital patterns. In some embodiments, the system will gamify sports play by making real-world sports performances feel like users are interacting with a video game by uniquely combining augmented reality, advanced sports motion data tracking, and video game characteristics. Users will be able to have a real-world sports competition experiences while playing in separate locations and time frames using augmented reality to map the playing field and add the goal, target or object of the game to the players world virtually.

In an embodiment, a water skier can use the app to find a water skier who is able to ski against them while they are in two different locations and the scoring system will be able to equalize/handicap the competition based on weather or other condition.

In another embodiment, users can create fantasy teams from data and statistic from pro sports play combine this with the real-sports action of individual players of any level of experience in in a single or a variety of sports.

In another embodiment, the application will include a virtual sports coach. This virtual coach will be able to establish goals and encourage the user to reach their next milestone. The application will be smart through machine learning and able to give real-time coaching feedback using artificial intelligence. The application will also enable the user to communicate with a real coach via SMS or video chat to receive feedback and encouragement.

In another embodiment, the system of multiplayer and multisport connectiveness allows for connecting coaches to players for virtual coaching sessions in real-time. This provides users with access to real-time coaching while allowing coaches to continue to provide a service from a remote location. This may be especially useful for coaches and athlete to interact remotely when in-person interactions are note permitted or are not possible. The system will allow the everyday athlete to access elite coaching and reduce the cost of receiving coaching through a demand cost and rating system. The system may also facilitate shortening the timeframe to access a number of coaches. Connecting real-time coaching to real-time video and sports motion data capture provides instant access of information to the player that is training or competing and the advances sports motion data enhances the assessment capabilities of the coach.

The system will connect millions of users into a virtual collaborative sports league, allowing for players of various skill level to compete including: amateur competition, pro competition, fantasy teams and wagering on hundreds of sports that are not currently possible due to both location, access to the athletes and accuracy of data collection.

Currently, the only sports wagering at this time is available on professional and mainstream sports play. For example, a person cannot wager on a women's bobsled team while they are training in Alaska on their home course. No one can currently wager from their desk on a professional water ski tournament on a lake in another state.

In yet another example, virtual tournaments or events can be set up in order that this application would allow wagering, for example a virtual fishing tournament. A fan can challenge two fishermen to a duel. These two fishermen can be anywhere in separate locations sending in their video and motion data of their catch and a virtual tournament would occur, while a third player/fan could bet/wager on the outcome of the virtual sports duel. The artificial intelligent judge of the data would determine the winner.

Further, the system allows for the gamification of real sports play while letting players compete with anyone, anywhere at any time. The application includes player interaction of real athletes in motion with virtual or augmented reality athletic play and/or video game play. For example, a kid could be shooting a free throw shot at home using AR goggles with a virtual basketball hoop and a ball with smart tracking device competing in real time directly against a player in a real basketball game such as a player at the NBA finals who is also shooting a free throw; meanwhile fans in the stands wager on the outcome of this virtual match play while all of this virtual play is behind the scenes not interfering with the normal game play action. The system will create the largest sports motion data collection system which will feed a machine learning and artificial intelligence algorithm that can be further be used for creating more complex competition, judging, unique mixing of level of players and a variety of sports and instruction.

In some embodiments, the system will eliminate the need for subjective judging for sports competition. This system to track advanced motion data of an athlete and compute that data into a scoring system will allow for accurate comparison. This system of advanced motion data collection will allow real judges to be replaced, especially subjective judging in sports like surfing, gymnastics and wakeboarding. For example, this system will allow a gymnast wearing smart fabric to feed all their body motions and advanced sport motion data to the system where it can be comparing an analyzed through AI, giving the athlete an objective score, a real perfect 10 for one or more sports motion data criteria in one performance.

In some embodiments, the system of measuring and gamifying the individual functions of team sports allowing new ways to compete. A system of capturing sports motion data of individual players in impact sports allows for competition without impact, potentially reversing the decline of interest in football, soccer, boxing, and the like due to fear of head trauma. Sports competition based on individual athlete play captured virtually allows for competition without impact. For example, the system will allow two boxers in different locations to compete in boxing based on specific patterns of training, speed of punches, movement of feet, strategy and the power of punch using a smart glove in operable communication with the system. The same system could be used for competition in football kicking and passing. This system solves important problem's facing impact sports.

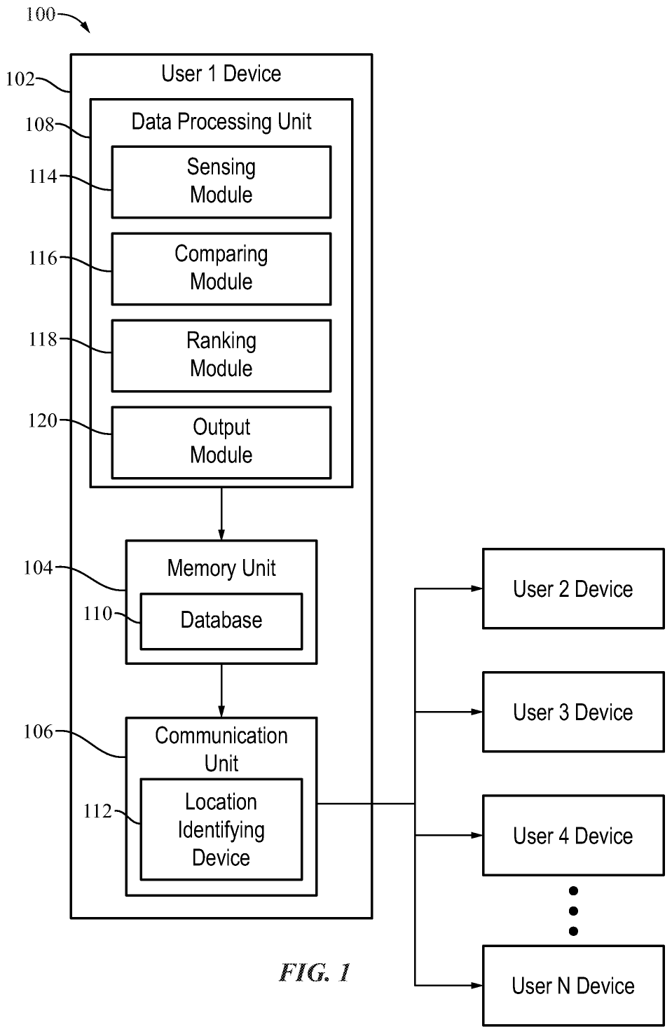

FIG. 1 provides exemplary illustration of a system 100 for collecting, storing, and disseminating sports performance and motion data of a user on a smart device over a wired or wireless network 101. The user's device 102 having a memory unit 104, a communication unit 106, and a data processing unit 108. The memory unit 104 comprises a database 110 with a variety of pre-programmed data, movements and inputs corresponding to a variety of sports and activities. The communication unit 106 comprises a location identifying device 112 for determining the actual location of the users such as the location services module of a smart device.

According to an embodiment, the data processing unit 108 comprises one or more modules and may include a microprocessor or microcontroller. The data processing system 108 includes at least one sensor 114, a comparing module 116, a ranking module 118 and an output module 120. At least one sensor, (video analytics is included as a sensor) is used to track and coordinate a user's movement and in real-time in accordance to the required performance data of the sports. The comparing module 116, via a processor and the communication unit 106 receives sports performance and motion data of one or more other users, to compare the sports performance and motion data of the user. The ranking module 118, via the processor calculates and ranks the users in accordance to the received compared data from the comparing module 116. The output module 120 is configured to display the rank, thereby providing a competitive sports performance experience to the user.

In some embodiments, the system tracks advanced motion data of an athlete and computes that data into a scoring system that allows for extremely accurate comparison. The increased accuracy of the data capture using smart products or fabrics combined with artificial intelligent will allow for wagering on individual sports and non-professional sports, even when players are in different locations and/or at different times.

The user's device 102 and processor are configured to collect and store a plurality of sports-related input such as motion data, range of motion, and speed and/or acceleration, and GPS location. The data processing unit 108 serves to execute instructions for software that may be loaded into the memory unit 104. The data processing unit 108 may be a number of processors, a multi-processor core, or some other type of processor, depending on the particular implementation. Further, the data processing unit 108 may be implemented using a number of heterogeneous processor systems in which a main processor is present with secondary processors on a single chip. As another illustrative example, the data processing unit 108 may be a symmetric multi-processor system containing multiple processors of the same type. The user's physical sport movement is tracked and analyzed for updating skills data and competitive rank for the user.

According to an embodiment, the data processing unit 108 determines a physical sport movement recommendation based on a sport being played and skills data for the user based on the sport being played, and one or more objects in a sport performance area in which the user is playing. The one or more processors control user 1 device display for displaying the virtual data for assisting the user in performing the physical sport movement recommendation from a user perspective associated with the display field of view. For example, when competing in match play in golf, two different users could play head-to-head on the same course while being in two separate geographic locations. The augmented reality data is configured to adjust the dimensions of the field to accommodate the sport and number of participants.

According to an embodiment, the sensing module 114 of the data processing unit 108 having one or more sensors directly, or over a communication network, measure and determine the movement of the users for the particular sports. Some examples of the sensors include video sensors, accelerometers, altimeters, GPS systems, depth image sensors, heat sensors, IR sensors, weight sensors, motion sensors, etc. In this example, the respective sensors are used to track the user movements and provide instant feedback through the processor in comparison to the received inputs of their competitor and provide a score and ranking (i.e., virtual leaderboard).

According to one embodiment, the comparing module 116 includes the data which is compiled from details of the predetermined game with the details having comparison information with the other user 2 device, user 3 device, user 4 device . . . user N devices. The comparing module 116 receives the data from the sensing module 114 regarding the user performance data. All the received data is compared with preset/user configured standards for comparing the user's performance. Also, users could select the game from a list of games and user information is provided in the system 100 to be stored in the memory unit 104. Data stored in the database 110 include reference data for one or more physical sport movements associated with the sport, and execution criteria for one or more associated movements. The comparing module 116 compares the data of user with other performers to rate the user, and/or the score against predetermined data sets for each sport, motivating the user to compete again virtually in the sport.

According to another preferred embodiment, the ranking module 118 calculates a score for each available physical sport movement based on the respective sport objective score and the user's execution score, or the environmental conditions score. For example, in some pre-determined sports, the ranking is calculated based on the user's body movement within the augmented virtual reality game. In one embodiment, sensing module tracks performance of pre-determined locations on the user's anatomy as commonly known and employed in the match moving arts.

According to a preferred embodiment the output module 120 displays the user's ranking based on set performance criteria stored in the memory unit 104. The user may be synchronized and ranked based on their location, gender, age, height, weight, and skill level. For example, families can compete against other families, players from a state or country against each other, by collecting all the scores of the user from various groups. Also, the augmented reality features are displayed via the output module 120, by the user field of view. User motion, and path of motion of a virtual sport object may also be displayed in the output module 120.

According to the preferred embodiment, the memory unit 104 includes a memory bus with memory controller, a peripheral bus, and a local bus. The memory includes read-only memory (“ROM”) and random-access memory (“RAM”). Program modules can be stored in the memory unit 104 including one or more application programs, other programs or modules, drivers and program data. The database 110 may include a repository for storing information and include a rule engine for each sport which accesses one or more rules corresponding to a pre-determined sport. Standard parameters are stored in the database 110. Data stored in the databases 110 include reference data for one or more physical sport movements associated with the pre-determined sport and execution criteria for the one or more associated movements. Also, the database 110 stores object properties for predetermined visual guides or previously generated visual guides and rule logic.

According to one embodiment, the communication unit 106 is configured to communicate with other devices either wired or wirelessly (for e.g., WiFi, Bluetooth, infrared, an infrared personal area network, RFID transmission, wireless Universal Serial Bus (WUSB), cellular, 3G, 4G or other wireless communication means) over one or more communication networks whether located nearby or at a remote location. The communication unit 106 having the location identifying device 112 stores location data for identifying the user location such as GPS data. Also, the location identifying device 112 with one or more GPS tracked proximate objects in the location from which other relative positions of real and virtual objects can be identified. Additionally, an IP address of a WiFi hotspot or cellular station to which the user 1 device 102 has a connection can identify a location. Additionally, identifier tokens may be exchanged on a device 102 via infrared, Bluetooth, or WUSB.

In an embodiment, the system comprises a wireless device having a memory unit, a communication unit, and a data processing unit. The memory unit may comprise a database with one or more sports related data, one or more skillsets required for measuring the performance of the user, and one or more performance data of the users. In one embodiment, the communication unit comprises a location identifying device (such as a GPS) for determining the actual location of the users which may be related to geographical information corresponding to the users location. In an embodiment, the data processing unit comprises one or more modules. The one or more modules are sensing modules, comparing modules, ranking modules, and output modules. The sensing module comprises one or more sensors to measure and determine the movement of the users in accordance to the required skill to be performed, and performance data of the preferred sports or activity. The comparing module, via a processor and communication unit, receives sports performance data of one or more other users to compare the sports performance data with user's sports performance data. The ranking module, calculates and ranks the users in accordance to the received compared data from the comparing module. The output module is configured to display the rank with respect to the user performance data, thereby motivating the user to keep interacting with the system and competing.

According to the preferred embodiment, the user 1 device 102 is an augmented reality eyewear such as a near-eye augmented reality (AR) display. Virtual data is collected using the near-eye augmented reality (AR) display of the eyewear. Using the augmented reality eyewear, the goal, buoy, or other obstacle is visible through the eyewear. For example, in water skiing game, the user may view the slalom course over the water including the buoys. In golf, the golfer can play a hole of golf anywhere with visible yardage markers. A hunter can see virtual game/animals/targets to shoot and the relevant distance and winds.

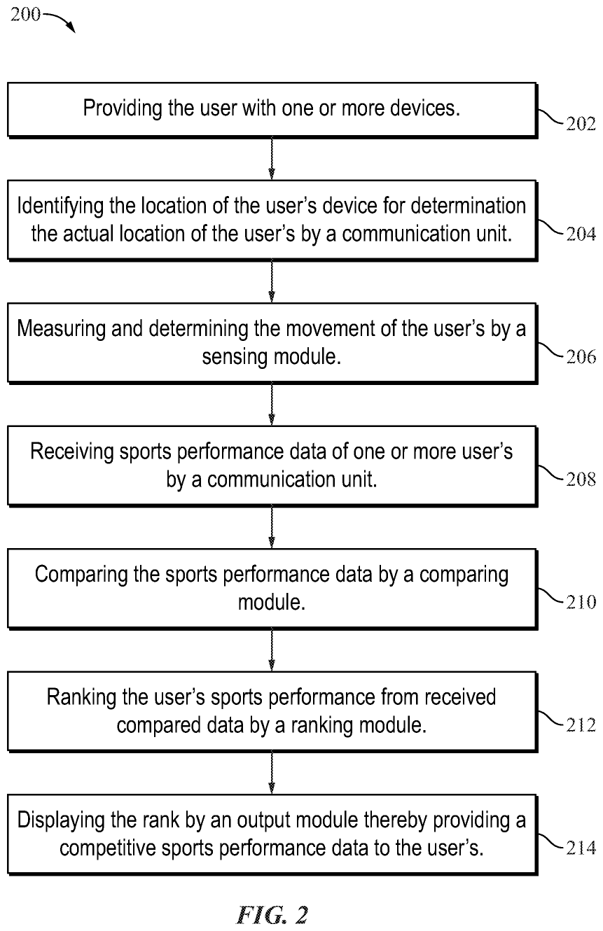

According to FIG. 2, a method 200 for providing sports performance data of the user comprises the following steps: providing the user with one or more devices in step 202. In step 204, the location of the user's device is identified for determining the actual location of the user by a communication module. Step 206 is to measure and determine the user's movement by a sensing module 114. Step 208 is to receive the sports performance data of one or more users by a communication module. Step 210 is to compare the sports performance data by a comparing module 116. Step 212 is to rank the compared sports performance of the users by a ranking module 118. Step 214 is to display the rank by an output module, thereby providing an example of the performance module of the system.

According to a further embodiment, the user can locate a competitor within the pre-determined sport for head-to-head competition. Alternatively, the system 100 may be used as training aid with an assigned coach or trainer who may implement a variety of workouts or drills to improve user performance and receive real-time feedback.

The system will capture the advanced sports motion data of multiple users allowing for real-time match play, team play of players not in the same location, fantasy team play of amateur and professionals on the same teams, wagering on new games and new sports, and new ways to judge and officiate sports. The system may include a means for recommending sport equipment adjustments and similar coaching information using machine learning and AI and a way to collect, value and store a lifetime of sports action digitally.

According to alternative embodiment, the system 100 captures sports performance data from a user and measures it against a set standard for purpose of attaining a sports score for competing against other players. Enhanced sports play could be achieved using augmented reality eyewear to show the user the obstacle or objects of the sports involved. The system 100 reduces the cost of travel and entry fees associated with traditional physical competitions. Users could be inspired to practice their sport or activity more often by having continuous data and feedback. The system 100 overcomes obstacles and barriers to entry that prevent more people from participating in sports by taking away the need to be in a specific location with required equipment. The system 100 motivates the user to achieve a high level of skill set by setting goals, measuring results and being inspired by competing with other players.

In some embodiments, the ranking module 118 corresponds a value to the user and to the users performances such that the user may be rewarded with a fiat currency, points, credits, or similar incentives for performing well in a sport activity. The system may motivate sports play by using operant conditioning through a variable reward system much like a video game or a slot machine. The system uniquely motivates sharing and viral growth by using a multi-level reward system for players, fans and businesses to share the application and encourage use.

The term “activity” can relate to any measurable activity that is engaged in by the users of the present invention. Examples herein include waterskiing and golf, however, it is understood that a multitude of activities can be measured, scored, and gamified over a network. Such activities can include, but are not limited to; downhill skiing, fishing, basketball, baseball, football, disc golf, surfing, wakeboarding, hunting, soccer, volleyball and most any other physical activity known.

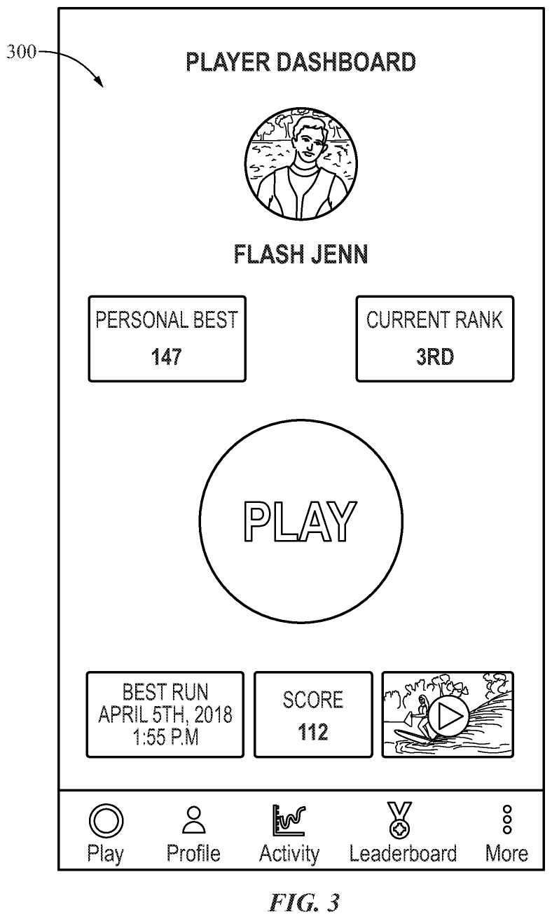

Now referring to FIG. 3, a screenshot of an application implementing the system 100 in a graphical user interface (“GUI”) is illustrated. It is understood that a multitude of activities can be modified to implement the system 100 described herein without parting from the spirit of the invention. In particular, FIG. 3 illustrates a user profile (e.g. dashboard) 300 wherein user-related metrics are displayed to the user. Metrics may include, but are not limited to, scores, rankings, records (e.g. personal best scores), and scores from the most recent activity engagement. In the present example, the GUI illustrates metrics related to a waterskiing activity. A recording can be presented on the screen, permitting the user to review their execution of the activity, a demonstration of the activity, or the execution of the activity by other users within the user community.

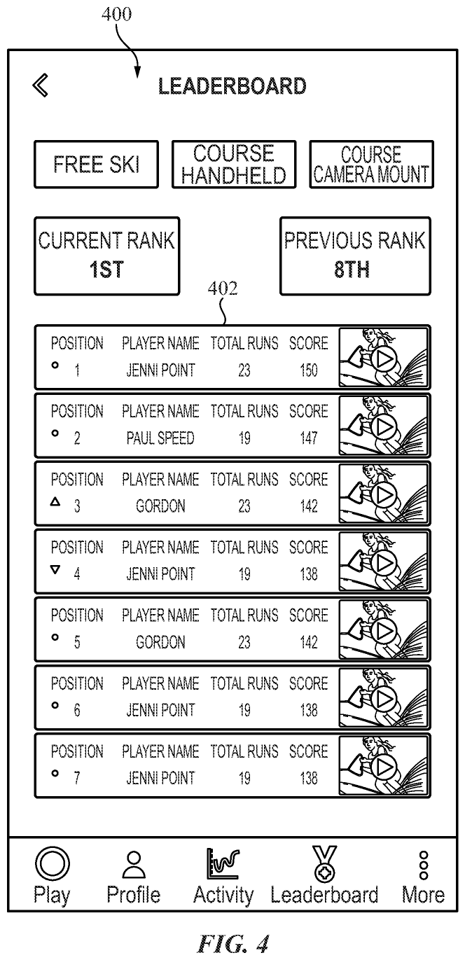

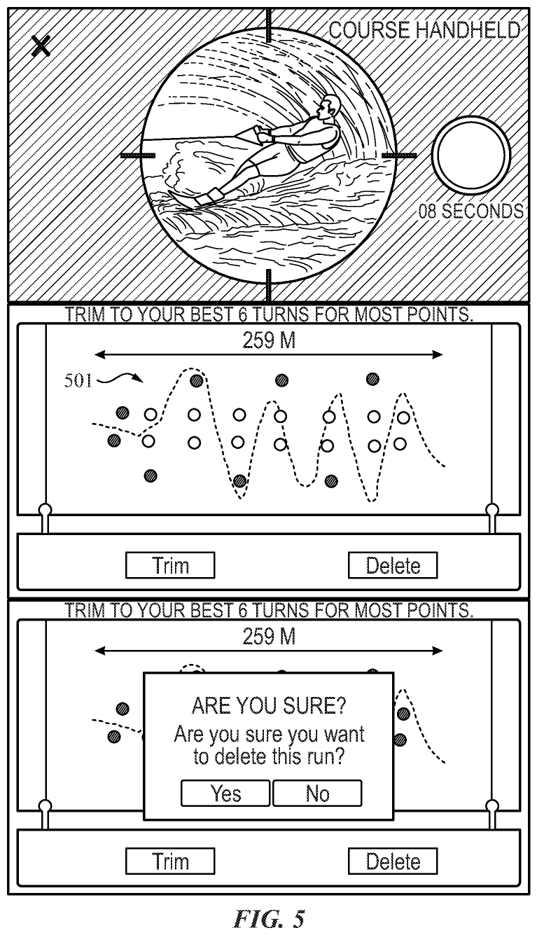

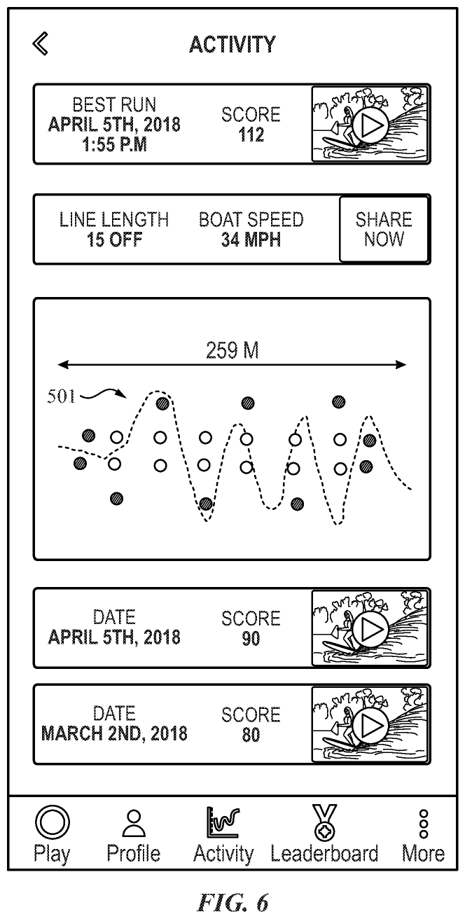

A leaderboard 400 is illustrated in FIG. 4. In the present embodiment, the leaderboard 400 includes a ranking for each of the plurality of users and specific trials 402 of the activity performed. Rankings are generated from the ranking module 118 as described above. FIGS. 5 and 6 illustrates the GUI illustrating the performance data 501 of the particular activity performed by the user. The performance data of the activity is determined using the sensor 114 transmitting data to the system 100 utilizing network 101. The comparing module 116 receives performance data and compares the performance data from user 1 to the collective data received from the community of users within the ecosystem or a collaborative space. The ranking module 118 produces the leaderboard 400 as illustrated having a plurality of metrics thereon in correlation with each trial.

In one embodiment, sensors 114 may include a handheld camera, a mounted camera, or similar video capturing device. The user may select from a menu to indicate which sensor 114 they intend to use to capture performance data 501. Optical recognition is utilized to determine how well the user executed the activity. In one example, the user engages with a waterski course while a handheld camera captures the execution thereof. A plurality of metrics, including but not limited to, speed of the user, turn initiation, acceleration, turn execution, distance, and other relevant metrics are captured using the handheld camera. Further, additional sensors may be utilized such as sensors positioned on the body of the user, on a towing device, or mounted on the waterski. These sensors may include any sensor relevant in the arts such as an accelerometer, GPS, timer, or similarly useful application.

In an embodiment, the user may target data to provide the comparing module 116 and ranking module 118 with an optimal set of performance data to achieve the highest score for a particular trial.

It is a goal of each sensor to characterize the motion of the user in a given activity. This can be accomplished in a plurality of ways including optical recognition of the user's movements, capturing data from sensors in communication with the user and/or devices utilized by the user, as well as objective data known in the arts. Performance data captured can be compared to previously stored performance data from a plurality of users who have previously engaged with the ecosystem. It is a goal of the system 100 to provide high-quality unbiased performance data. This is especially valuable in activities which currently rely on analysis from judges such as surfing and figure skating. It is also a goal to provide gamification of pre-determined sports in a variety of locations. For example, the system will allow a user to compete in a virtual golf match from any location without having to travel to a golf course or driving range.

The use of a camera with optical sensors can be useful in an activity wherein the motion of the user is generally irregular or unpredictable. This can include activities such as biking, surfing, snowboarding, skiing, skateboarding, and where scored are objectively measured. The camera, in addition to a plurality of sensors can be utilized to better analyze, compare, and rank a performance in the pre-determined sports from the user's performed movements.

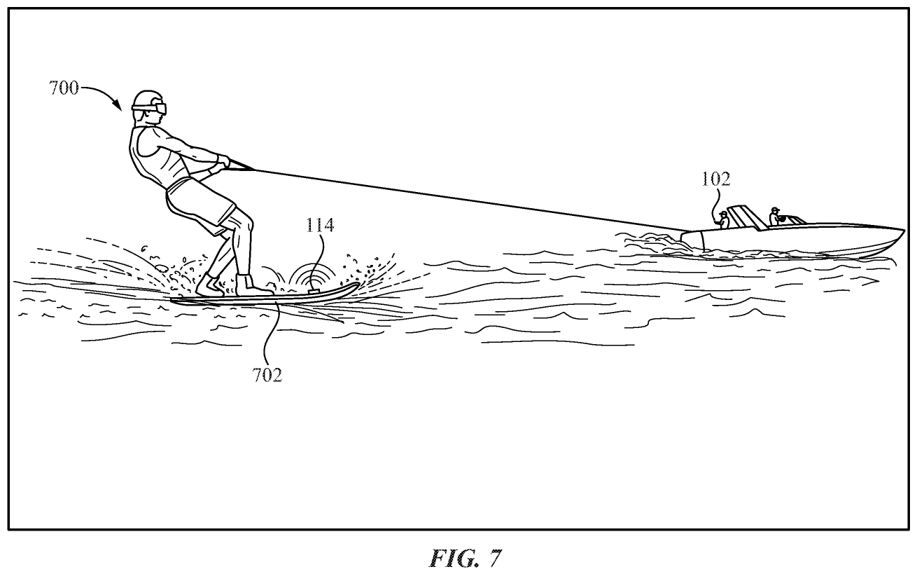

In reference to FIG. 7, a schematic of a user 700 performing an activity (waterskiing) with a virtual or augmented reality device 802 is illustrated. Waterskiing requires the use of a towing device (i.e. a boat having an affixed rope and handle) and an activity-associated device (waterski) 702 affixed to the user 700. A sensor 114 can be mounted to the waterski 702 to sense and transmit data related to the performance of the user 700. At least one recording device 704, such as a camera, can be positioned within a recording range of the user 700 throughout the activity. In the present embodiment, the sensor 114 mounted to the waterski 702 comprises one or more accelerometers, gyroscopes, compasses, and GPS to record and transmit the performance of the user 700. Transmission of data can be accomplished by a wireless transceiver coupled to the sensor 114 to transmit the data over the wireless network 101 via RF, Bluetooth, cellular, PAN, satellite, or similar network transmissions. Similarly, the recording device 704 transmits data via network 101 to be utilized within the system 100 as described hereinabove. Each recording can be retrievable via the connected system 100 and server thereof such that recorded data can be later accessed by users. In one embodiment, user device 102 records the waterskiing activity in a similar manner as the recording device 704.

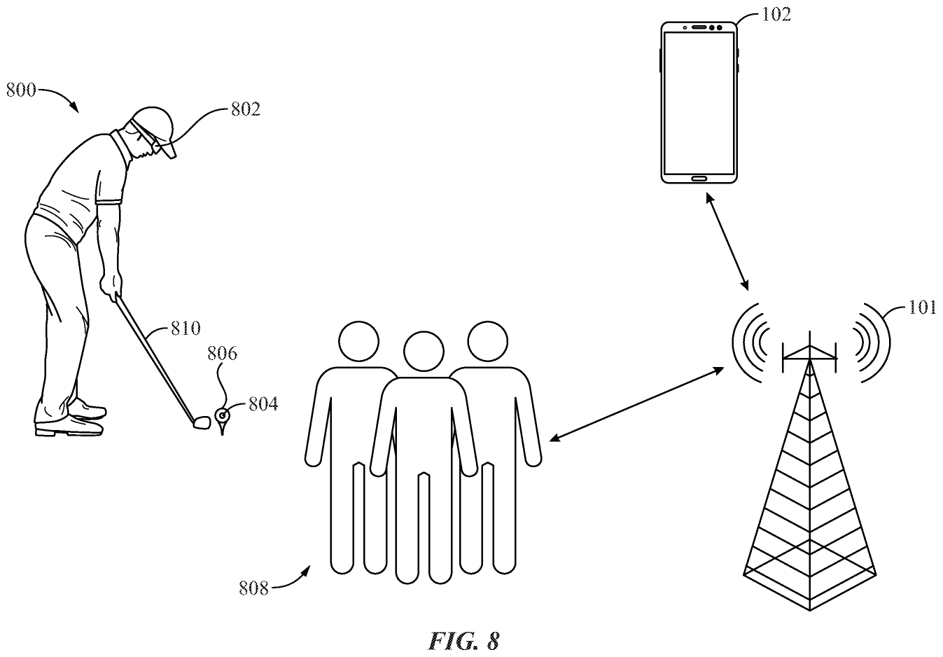

FIG. 8 illustrates an embodiment wherein a user 800 is competing in golf. The user can utilize an augmented or virtual reality device 802 to visualize and engage with other users within system 100. Sensors 114 can be disposed within the activity associated device 810 (such as the golf club) to measure, record, and transmit a multitude of metrics related to the activity of golf. Further, a secondary sensor 804 can be positioned within the golf ball 806 to measure, record, and transmit data related thereto. In a further embodiment, a camera or other user device 102 can be suitably positioned to visualize the user 800 during the various aspects of their swing.

It is a goal of the present invention to not only gamify pre-determined sports or activities, but to also allow the interaction between a plurality of users 808 in real-time. In this manner, ratings, metrics, scores, and other content can be displayed to each of the user utilizing the network 101 connected device 102.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for providing sports performance and motion data of a user, the system comprising:
a processor having an integrated memory unit and configured to collect and compare the following:
a plurality of user input corresponding to a specific sport and a user's performance, the memory unit comprising a database with one or more performance data of the user;
a communication unit comprising a location identifying device for determining the actual location of the users;
a data processing unit comprising:
a sensing module comprising one or more sensors to measure and determine the movement of the users in accordance to the required performance data of the sports;
a comparing module to receive, via a processor and the communication unit, sports performance data of one or more other users to compare the sports performance data;
a ranking module to calculate and rank the users in accordance to the received compared data from the comparing module; and
an output module configured to display the rank, thereby providing the sports performance data to the users.

2. The system of claim 1, wherein activity performance data is gamified and displayed via a graphical user interface.

3. The system of claim 2, wherein gamification occurs in real-time in relation to the first user.

4. The system of claim 3, further comprising at least one device sensor in analytical communication with an activity-associated device, wherein the at least one device sensor transmits device data to the data processing unit.

5. The system of claim 4, wherein performance data is aggregated from a plurality of users within a community via the database.

6. The system of claim 5, further comprising a plurality of auxiliary devices each in analytical communication with at least one secondary activity-related device, wherein the plurality of auxiliary devices transmits performance data to the processing unit.

7. The system of claim 6, further comprising a camera, wherein the camera is used to capture the user's performance data.

8. The system of claim 7, wherein a personal electronic device is utilized to capture activity performance data.

9. The system of claim 8, further comprising an augmented or a virtual reality device in communication with the data processing unit.

10. A method of implementing an activity performance data system, the method comprising:
identifying the location of the user's device for determination the actual location of the users by a communication module;
measuring and determining the movement of the users using a sensing module;
receiving sports performance data of one or more users using a communication module;
comparing the sports performance data using a comparing module;
ranking the user's sports performance from received compared data using a ranking module; and
displaying the rank using an output module thereby providing a competitive sports performance data to the users.

11. The method of claim 10, further comprising:
a processor having an integrated memory unit and configured to collect and compare a plurality of user input corresponding to a specific sport and a user's activity performance;
a database with one or more activity performance data related to each user;
a communication unit including a location identifying device for determining the actual location of each user;
a data processing unit comprising at least one of the following:
a sensing module in communication with one or more sensors to measure and determine the movement of the users in accordance to the required performance data of a particular activity;
a comparing module to compare, via the processor, the activity performance data;
a ranking module to calculate and rank, via the processor, the users in accordance to the received compared data from the comparing module; and
an output module configured to display the rank, thereby providing a competitive activity performance data to the users.

12. The method of claim 11, further comprising at least one device sensor mounted to an activity-associated device, wherein at least one device sensor transmits performance data to the data processing unit.

13. The method of claim 12, further comprising a plurality of auxiliary devices each in analytical communication with at least one secondary activity-related device, wherein the plurality of auxiliary devices transmits performance data to the processing unit.

14. The method of claim 13, further comprising a camera, wherein the camera tracks the user's activity performance.

15. The method of claim 14, further comprising an augmented or virtual reality device in communication with the data processing unit.

16. The method of claim 15, wherein the output module is configured to display the rank of each user on a graphical user interface, wherein the output module utilizes a wireless network.

17. The method of claim 16, wherein the performance data is aggregated from a plurality of users within a community.

18. The method of claim 17, wherein a personal electronic device is utilized to capture the performance data.

19. The method of claim 18, wherein the plurality of users communicates and compete against one another in a common activity, via the wireless network.

20. A system for providing the gamification of an activity performance and motion data by combining real activities, augmented reality, virtual reality and video game features, the system comprising:
a processor having an integrated memory unit and configured to collect and compare a plurality of user input corresponding to a pre-determined sport and a user's performance during the pre-determined sport;
a database with one or more activity performance data related to each user;
a communication unit including a location identifying device for determining the actual location of at least a first player and at least a second player;
a data processing unit comprising at least one of the following:
a sensing module in communication with one or more sensors to measure and determine the movement of the users in accordance to the required performance data of a particular activity;
a comparing module to compare, via the processor, the activity performance data;
a ranking module to calculate a rank, via the processor, of each of the users in accordance to the received compared data from the comparing module; and
an output module configured to display the rank of each of the users, thereby providing a competitive activity performance data to the users.
